(19) United States
(12) Patent Application Publication
(10) Pub. No.: US 2013/0022894 A1
(43) Pub. Date: Jan. 24, 2013

(54) ePTFE-Supported Polyelectrolyte Membranes Made with Ionomer-Kynar Blends

(71) Applicants: Lijun Zou, Rochester, NY (US); Timothy J. Fuller, Pittsford, NY (US); Michael R. Schoeneweiss, West Henrietta, NY (US)

(72) Inventors: Lijun Zou, Rochester, NY (US); Timothy J. Fuller, Pittsford, NY (US); Michael R. Schoeneweiss, West Henrietta, NY (US)

(73) Assignee: GM GLOBAL TECHNOLOGY OPERATIONS LLC, Detroit, MI (US)

(21) Appl. No.: 13/186,917

(22) Filed: Jul. 20, 2011

(51) Int. Cl. H01M 8/10

(52) U.S. Cl. 429/494

(57) ABSTRACT

A composite membrane for fuel cells includes an expanded polytetrafluoroethylene substrate having a predefined void volume, a first polymer and a second polymer each of which fill at least a portion of the void volume. The first polymer includes the following chemical moiety:

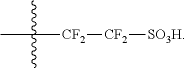

Polymer electrolyte membranes and fuel cells incorporating the composite membrane are also provided.

### TECHNICAL FIELD

The field to which the disclosure generally relates to polymeric electrolytes and to fuel cells incorporating such polymeric electrolytes.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles to promote oxidation of hydrogen at the anode and reduction of oxygen at the cathode. Protons flow from the anode through the ionically conductive polymer membrane to the cathode where they combine with oxygen to form water, which is discharged from the cell. The MEA is sandwiched between a pair of porous gas diffusion layers (“GDL”), which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

Accordingly, an improved polymer electrolyte molecular architecture and a process of synthesizing such a polymer electrolyte are desired.

### SUMMARY OF THE INVENTION

The present invention solves one or more problems of the prior art by providing in at least one embodiment a composite ion-conducting membrane that is useful for fuel cell application. The composite membrane of the present embodiment includes a support structure having a predetermined void volume. A polymeric electrolyte composition contacts the support structure. The polymeric electrolyte composition includes a first polymer that includes the following moiety:

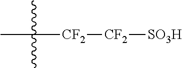

and a second polymer composition that includes a non-ionic polymer.

In another embodiment of the present invention, a method of forming the composite membrane set forth above is provided. The method of this embodiment comprises a step in which a support structure is contacted with a first polymer-containing solution. The support structure is formed from a polymer and has a predetermined porosity such that the first polymer-containing solution penetrates into interior regions of the support structure defined by the predetermined porosity. The first polymer-containing solution coats at least a portion of the interior regions to form a first coated support structure. The first coated support structure is coated with a second polymer-containing solution that penetrates into interior regions of the first polymer-coated support structure to form a second coated support structure. Penetration of the second polymer-containing solution is enhanced by the first ionomer solution as compared to a support structure that is not coated by the first ionomer solution. Finally, solvent is removed from the second coated support structure to form the composite membrane. An additional coating of the second polymer solution can be applied so that the support structure is sandwiched between two layers of the second polymer (ionomer).

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 provides a schematic illustration of a fuel cell incorporating the polymers of an embodiment of the present invention;

FIG. 2 provides a schematic illustration for an embodiment of the composite membrane;

FIGS. 3A and 3B provides scanning electron microscopy top-down images of expanded polytetrafluoroethylene supports of Tetratex® 1326 and 1324 (Donaldson);

FIG. 4 provides tensile, elongation, and mechanical properties of a brittle ionomer (Tetramer GTLP), fluororubber (Arkema, Kynar Flex 2751) and ePTFE support (Donaldson Tetratex® 1326); and

FIG. 5 provides plots of the proton conductivity versus relative humidity (RH) for GTLP, Nafion DE2020, GTLP with 20% Kynar and a thin ePTFE, and GTLP with 20% Kynar and a D1326 ePTFE.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” “block”, “random,” “segmented block,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

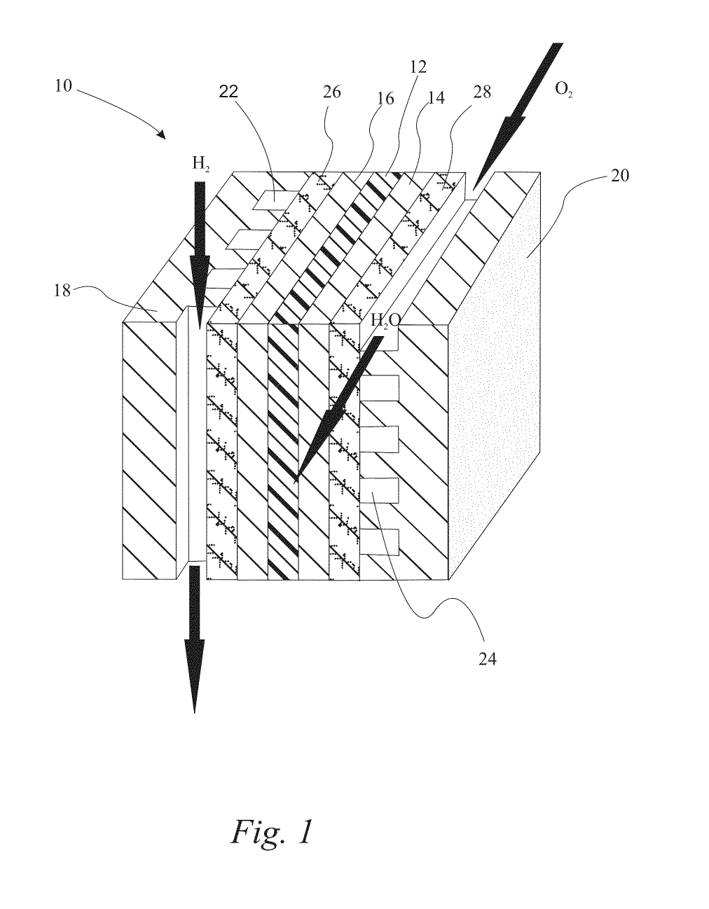

With reference to FIG. 1, a fuel cell that incorporates a polymer electrolyte including polymers from the invention is provided. PEM fuel cell 10 includes polymeric ion conductive composite membrane 12 disposed between cathode catalyst layer 14 and anode catalyst layer 16. Polymeric ion conductive membrane 12 includes one or more of the polymers set forth below. Fuel cell 10 also includes conductive plates 18, 20, gas channels 22 and 24, and gas diffusion layers 26 and 28.

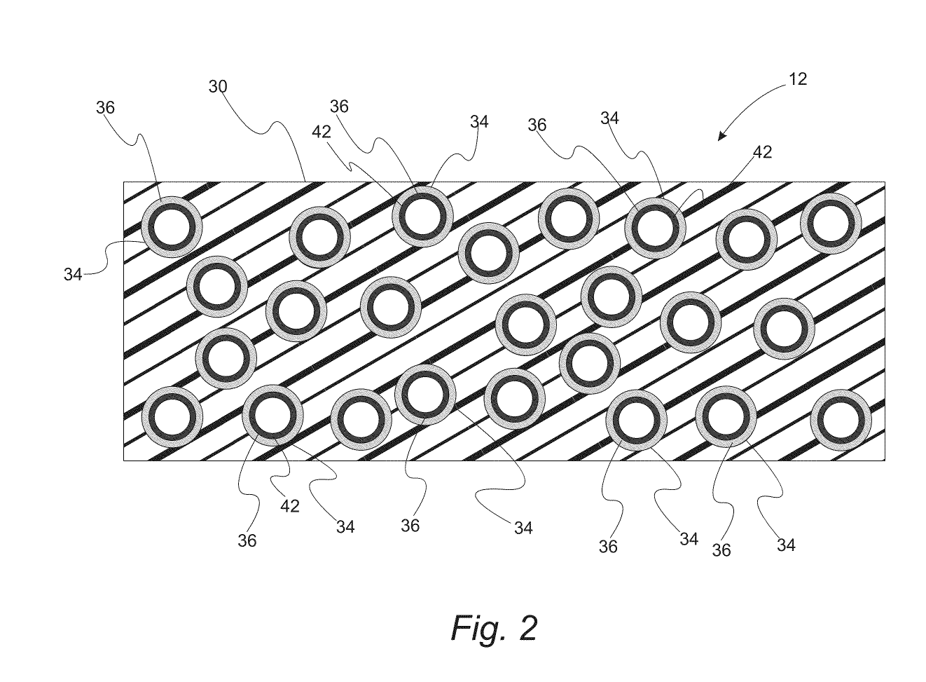

In an embodiment of the present invention, a composite membrane for use in an electrochemical cell is provided. FIG. 2 provides a cross-section of a portion of the composite membrane. The size of the pores is exaggerated for purposes of illustration. Composite membrane 12 includes support structure 32 having a predetermined void volume due to the presence of voids 34. Typically, the void volume is from 30 volume percent to 95 volume percent of the total volume of support structure 30. Support structure 32 may be formed from virtually any polymeric material having the requisite void volume. Expanded polytetrafluoroethane is particularly useful for this application. Polymeric electrolyte composition 36 contacts support structure 32. Polymeric electrolyte composition 36 includes a first polymer that includes the following moiety:

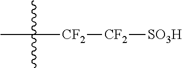

Polymeric electrolyte composition 34 also includes a second polymer that is a non-ionic polymer. In a refinement, at least 50 percent of the void volume includes polymeric electrolyte composition 36, i.e., is filled with the polymeric electrolyte composition.

Still referring to FIG. 2, composite membrane 12 is formed by contacting support structure 32 with a first polymer-containing solution (i.e., a solution containing the first polymer set forth above). The first polymer-containing solution contains a polymer having the following chemical moiety:

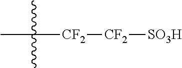

and a suitable solvent. Examples of such solvents include alcohols, water, N,N-dimethylacetamide, etc. In a refinement, the first polymer-containing solution comprises an ionomer in an amount from about 0.1 weight percent to about 5 weight percent of the total weight of the first ionomer solution. In another refinement, the first polymer-containing solution comprises an ionomer in an amount from about 0.5 weight percent to about 2 weight percent of the total weight of the first ionomer solution. The first polymer-containing solution penetrates into interior regions of support structure 32 such as void 34. At least a portion of the interior regions are coated with the first polymer-containing solution to form the first coated support structure. The first coated support structure is subsequently coated with a second polymer-containing solution (i.e., the second polymer set forth above) that penetrates into interior regions of the coated support structure to form a second coated support structure. Penetration of the second polymer-containing solution is enhanced by the first polymer-containing solution as compared to a supported structure or support membrane that is not coated by the first polymer-containing solution. Solvent(s) are then removed from the ionomer coated support membrane to form composite membrane 12. Therefore, composite membrane 12 includes first layer 36, which contacts at least a portion of support structure 32 and is disposed over a portion of the void volume such as void(s) 34. First layer 36 comprises residues of the first polymer-containing solution. In a variation, composite membrane 12 also includes second layer 42 contacting at least a portion of the first layer. Second layer 42 comprises residues of a second polymer-containing solution.

As set forth above, the composite membrane includes a first polymer that includes a cyclobutyl moiety. In a variation, the first polymer includes a sulfonated-perfluorocyclobutane polymer. The first polymer is applied within the first ionomer solution. Ideally, the void volume 36 is completely filled with ionomer after drying.

In another exemplary embodiment, the first polymer is a perfluorosulfonic acid polymer (PFSA). In a refinement, the first polymer is a copolymer containing repeating units based on tetrafluoroethylene and repeating units represented by (CF₂—CF)—(OCF₂CFX)ₘ—Oₚ—(CF₂)ₙ—SO₃H, where X represents a fluorine atom or a trifluoromethyl group, m represents an integer from 0 to 3, n represents an integer from 1 to 12 and p represents an integer of 0 or 1. Specifically, the first example would be represented by m=1, X=CF₃, p=1, n=2; the second example would be represented by m=0, p=1, n=2 and the third example would be represented by m=0, p=1, n=4.

In a further refinement, the first polymer is selected from the group consisting:

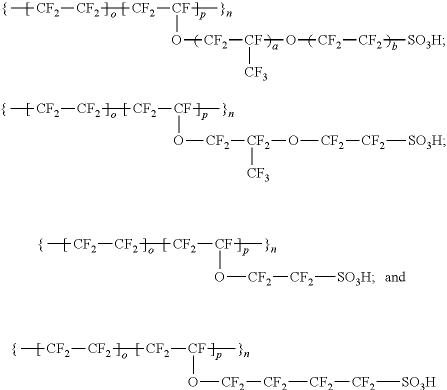

where o, p, n, are integers such that there are less than 15 o segments for each p segment.

In another refinement, the first polymer includes at least one of the following polymer segments:

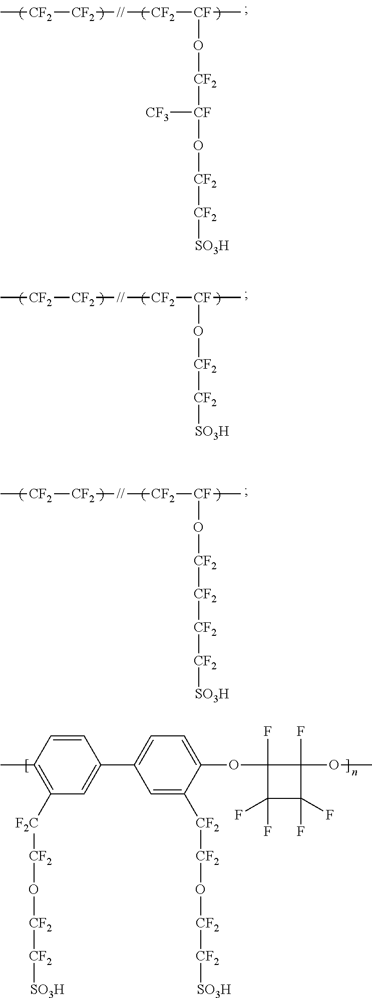

As set forth above, the composite membrane includes a second polymer which is a non-ionic polymer. Examples of such non-ionic polymers include, but are not limited to, fluoropolymers. In a variation of an exemplary embodiment, the non-ionic polymer are fluoroelastomers. The fluoro-elastomer may be any elastomeric material comprising fluorine atoms. The fluoro-elastomer may comprise a fluoropolymer having a glass transition temperature below about 25° C. or preferably, below 0° C. The fluoro-elastomer may exhibit an elongation at break in a tensile mode of at least 50% or preferably at least 100% at room temperature. The fluoro-elastomer is generally hydrophobic and substantially free of ionic groups. The fluoro-elastomer polymer chain may have favorable interaction with the hydrophobic domain of the second polymer described above. Such favorable interaction may facilitate formation of a stable, uniform and intimate blend of the two materials. The fluoro-elastomer may be prepared by polymerizing at least one fluoro-monomer such as vinylidene fluoride, tetrafluoroethylene, hexafluoropropylene, vinylfluoride, chlorotrifluoroethylene, perfluoromethylvinyl ether, and trifluoroethylene. The fluoro-elastomer may also be prepared by copolymerizing at least one fluoro-monomer and at least one non-fluoro-monomer such as ethylene, propylene, methyl methacrylate, ethyl acrylate, styrene, vinylchloride, vinylidene chloride and the like. The fluoro-elastomer may be prepared by free radical polymerization or anionic polymerization in bulk, emulsion, suspension and solution. Examples of fluoro-elastomers include poly(tetrafluoroethlyene-co-ethylene), poly(vinylidene fluoride-co-hexafluoropropylene), poly(tetrafluoroethylene-co-propylene), terpolymer of vinylidene fluoride, hexafluoropropylene and tetrafluoroethylene, and terpolymer of ethylene, tetrafluoroethylene and perfluoromethylvinylether. Some of the fluoro-elastomers are commercially available from Arkema under trade name Kynar Flex and Solvay Solexis under the trade name Solef® and Technoflon®, from 3M under the trade name Dyneon®, and from DuPont under the trade name Viton®. For example, Kynar Flex 2751 is a copolymer of vinylidene fluoride and hexafluoropropylene with a melting temperature between about 130° C. and 140° C. The glass transition temperature of Kynar Flex 2751 is about −40 to −44° C. The fluoro-elastomer may further comprise a curing agent to allow crosslinking reaction after blending with the second polymer. Herein, fluoropolymer rubber, fluoroelastomer, and fluoropolymer are used interchangeably.

In one refinement, the first polymer is present in an amount from about 20 to about 99 weight percent of the combined weight of the first and second polymers. In another refinement, the first polymer is present in an amount from about 50 to about 95 weight percent of the combined weight of the first and second polymers. In still another refinement, the first polymer is present in an amount from about 30 to about 90 weight percent of the total weight of the combined weight of the first and second polymers. In another refinement, the second polymer is present in an amount from about 1 to about 80 weight percent of the combined weight of the first and second polymers. In another refinement, the second polymer is present in an amount from about 5 to about 50 weight percent of the combined weight of the first and second polymers. In another refinement, the second polymer is present in an amount from about 10 to about 30 weight percent of the combined weight of the first and second polymers

In another embodiment of the present invention, a method of forming the composite membrane set forth above is provided. The method of this embodiment comprises a step in which a support structure is contacted with a first polymer-containing solution. The support structure is formed from a polymer and has a predetermined porosity such that the first polymer-containing solution penetrates into interior regions of the support structure defined by the predetermined porosity. The first polymer-containing solution coats at least a portion of the interior regions to form a first coated support structure. The first coated support structure is coated with a second polymer-containing solution that penetrates into interior regions of the first polymer-coated support structure to form a second coated support structure. Penetration of the second polymer-containing solution is enhanced by the first ionomer solution as compared to a support structure that is not coated by the first ionomer solution. Finally, solvent is removed from the second coated support structure to form the composite membrane. An additional coating of the second polymer solution can be applied so that the support structure is sandwiched between two layers of the second polymer (ionomer). Moreover, the second polymer solution contains between 1 and 50 weight percent of a fluorinated rubber such as Kynar Flex 2751 (Arkema) or Solef 21216, 11008, 21508, and 31508 (Solvay-Solexis). The fluorinated rubber adds additional elasticity to the membrane, improves elongation to break, and reduces water uptake by the membrane. The result is a membrane with improved durability over that of the membrane with fluorinated rubber alone or with ePTFE support alone. Suitable perfluorosulfonic acid ionomers include Asahi Glass IG100, DuPont de Nemours DE2020 (Nafion® 1000), Asahi Kasei SS1100 and SS900, 3M 700, 825 and 1000, Solvay-Solexis D70-20BS, 850-15BS, Tetramer Technologies GTLP and MCS, and the like.

The following examples illustrate the various embodiments of the present invention. Those skilled in the art will recognize many variations that are within the spirit of the present invention and scope of the claims.

### Example 1

### Pretreatment of Expanded Tetrafluoroethylene Supports

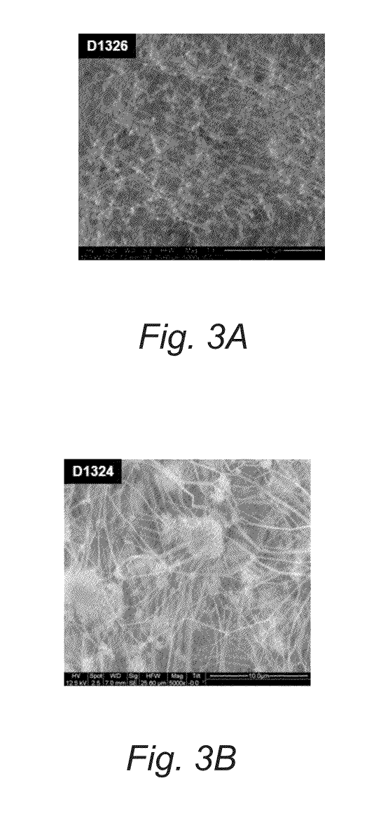

Top-down scanning electron microscope (SEM) images of the expanded poly(tetrafluoroethylene) (ePTFE) supports Tetratex 1326 and 1324 (Donaldson) are shown in FIG. 3. D1326 is a tighter, less porous structure and is more mechanically robust than that of D1324. The ePTFE support is situated in an embroidery scroll frame (Homecrafters) and then rolled and stretched to remove the wrinkles A 20 weight percent solids solution of Nafion® 1000 (DE2020 in a 2:3 ratio of n-propanol and water) is diluted to a 1 weight percent solid with isopropanol and the solution is applied to a release backer sheet of tetrafluoroethylene-hexafluoropropylene copolymer (FEP), which is situated on a vacuum platen, with the use of a 3-mil Bird applicator (Paul E. Gardner Co.). The opaque ePTFE support in the frame is laid onto the wet coating and the solution imbibes into the support that immediately becomes transparent. After air-drying or solvent removal with heat, the ePTFE support again becomes opaque. This treated ePTFE support, while still in the frame, is removed from the backer sheet.

### Example 2

### Membrane Preparation with DE2020, Kynar Flex 2751 and ePTFE (D1326)

A solution of DE2020 ionomer (Nafion® 1000, DuPont de Nemours) is freeze dried from water to a solid with care not to heat the residue at any time above 80° C. To this solid ionomer is added Kynar Flex 2751 (Arkema) at 30 weight percent of the polymer solids, and then N,N-dimethylacetamide is added to prepare a solution with an overall concentration of 10 weight percent solids. Using a 3-mil Bird applicator, the solution is coated onto an FEP backer sheet that is situated on a vacuum platen of an Erichsen coater. The treated ePTFE support of Example 1, while still in the frame, is laid quickly onto the wet layer. The solution of DE2020 ionomer with Kynar Flex 2751 readily imbibes into the ePTFE support and the transparent composite is then heated at 80° C. until the composite is dry to the touch. An optional second layer is applied using a 3-mil Bird applicator that rides on a 50-micron thick tape layer to prevent scuffing of the coated membrane. The composite is then heated at 80° C. until dry (usually 15 minutes) and then is optionally heated at 140° C. for at least one hour to anneal the membrane. The resultant membrane consisting of DE2020 ionomer, Kynar Flex 2752 and ePTFE support is peeled from the backer sheet then is sandwiched between two electrode layers made by coating platinum nanoparticles on carbon black (Tanaka, with a DE2020 ionomer binder) onto a microporous layer on diffusion media consisting of graphitized carbon fibers (Mitsubishi Rayon Corporation). The cathode platinum loading is 0.4 mg/cm² and the anode loading is 0.04 mg/cm². This membrane is operated for 700 hours with continuous measurement of polarization curves at 85%, 150%, 85%, and 75% RH gas outlets at 80° C. between 0 and 1.5 A/cm² until the test is stopped without any serious performance loss. This membrane withstands more than 20,000 wet-dry cycles oscillating between two minutes at 150% RH and two minutes at 0% RH. The membranes fails by ductile failure after more than 200% elongation to break instead of by tearing as is the case with either the unsupported DE2020 membrane with Kynar Flex 2751 alone or with the ePTFE (D1326)-supported DE2020 membrane alone, in the absence of Kynar Flex 2751. Lesser or greater amounts of Kynar Flex 2751 can be used to tailor the mechanical properties of the composite membrane. The membranes made with DE2020, Kynar Flex 2751 and ePTFE support (D1326) are more durable in fuel cell tests than those membranes made in the same way with the ePTFE support D1329 (same as D1324). In short stack testing, large active area membranes prepared as described above have survived more than 3000 hours of accelerated durability testing at 80° C., at which time the test was stopped.

### Example 3

### Membrane Preparation with Alternative ePTFE Supports

Other alternative ePTFE supports, which are obtained from other suppliers including Ningbo, Lingquaio, and Dagong, are treated as in Example 1 with similar results. Membranes with these supports are made as described in Example 2. Membranes made using the combination of ePTFE support, Kynar Flex 2751, and DE2020 ionomer are superior to those with either ionomer and ePTFE alone or with ionomer and Kynar Flex alone without the ePTFE support.

### Example 4

### Membrane Preparation with Alternative Fluoropolymer Rubber Additives to ePTFE-Supported Membranes

Besides Kynar Flex 2751 (Arkema), other fluoropolymer rubbers that were tested in membranes which are prepared as described in Example 2 (and listed in order of preference) include Solef 21216, 11008, 21508, and 31508 (Solvay-Solexis). Solef 21216 and 11008 behave similarly to Kynar Flex 2751.

### Example 5

### Membrane Preparation with Alternative PFSA Ionomers with Fluoropolymer Additives in ePTFE Supports

Other alternative perfluorosulfonic acid ionomers to DE2020 (Nafion® 1000, DuPont de Nemours) which were made into membranes with ePTFE support (D1326) and Kynar Flex 2751 as described in Example 2 include Asahi Glass IG100, Asahi Kasei SS1100, SS900 and SS700, 3M 700 EW, 825 EW and 100 EW, Solvay-Solexis D70-20BS, 850-15BS, and Tetramer Technologies GTLP and MCS. These membranes with ePTFE supports (D1326) and Kynar Flex 2751 all show improved mechanical durability with excellent fuel cell performance.

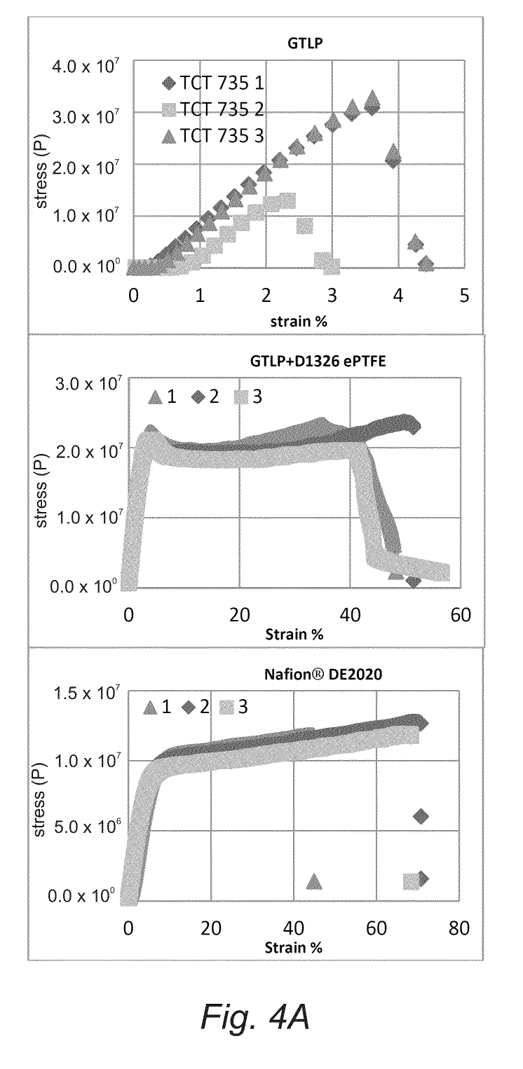

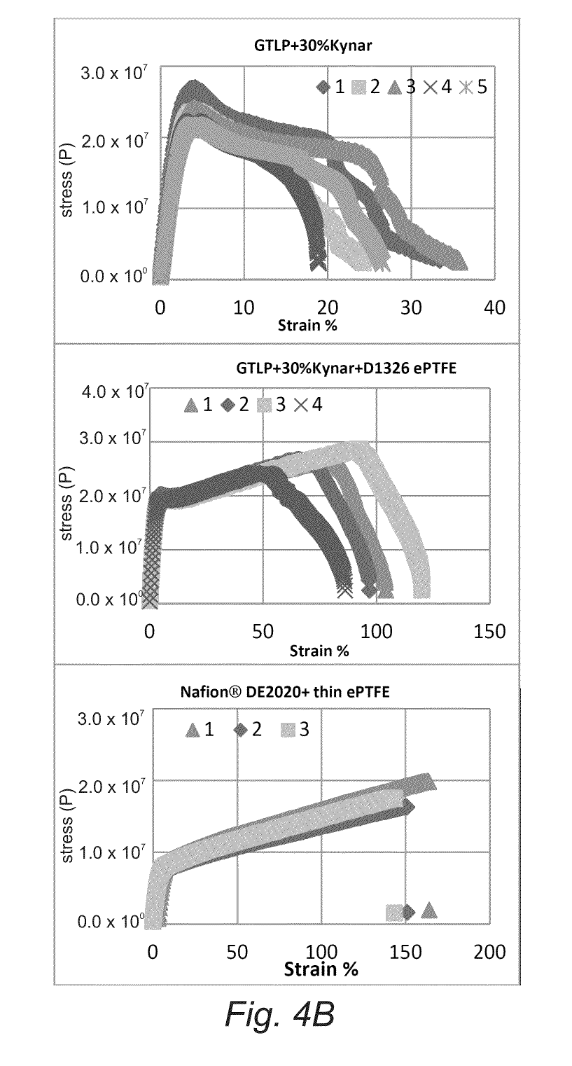

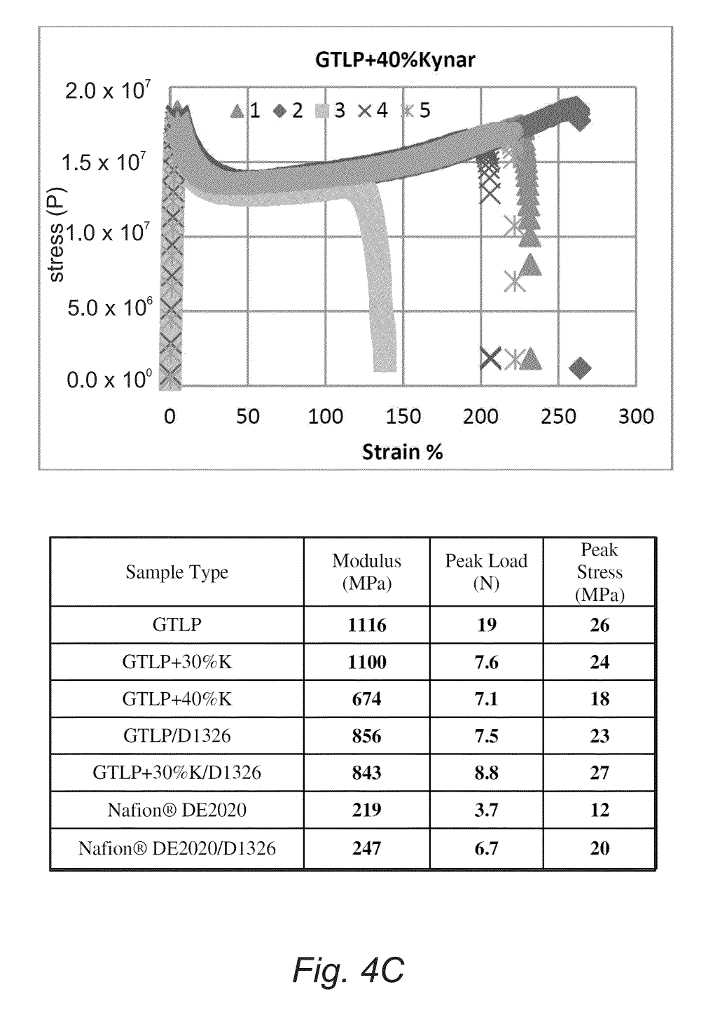

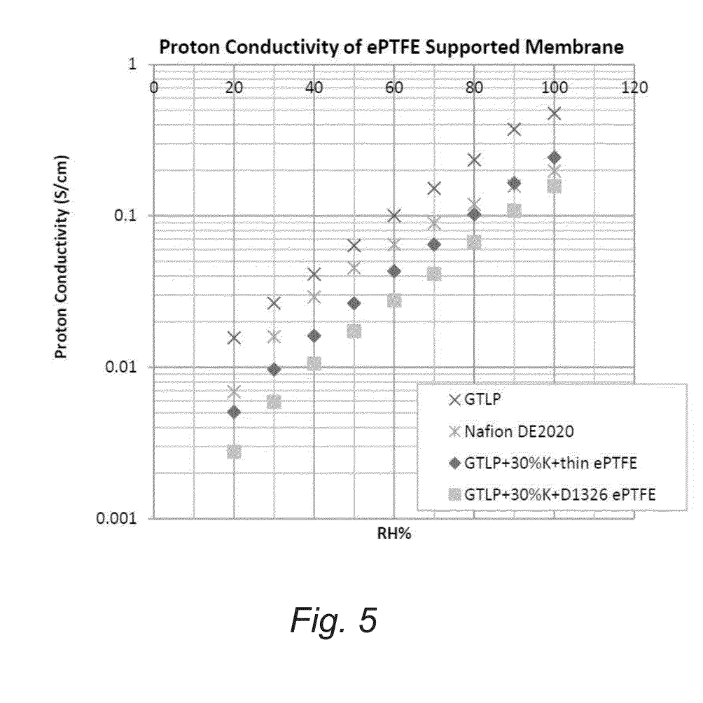

FIG. 4 provides tensile, elongation, and mechanical properties of a brittle ionomer (Tetramer GTLP), fluororubber (Arkema, Kynar Flex 2751) and ePTFE support (Donaldson Tetratex® 1326). This figure demonstrates that the properties of the ionomers of the present invention are useful for fuel cell applications. FIG. 5 provides plots of the proton conductivity versus relative humidity (RH) for GTLP, Nafion DE2020, GTLP with 20% Kynar and a thin ePTFE, and GTLP with 20% Kynar and a D1326 ePTFE. FIG. 5 shows that the membranes of the present invention have suitable proton conductivities for fuel cell applications.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A composite membrane for fuel cells, the composite membrane comprising:
an expanded polytetrafluoroethylene substrate having a predefined void volume;
a first polymer having a chemical moiety described by formula (I): 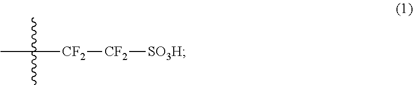
and
a second polymer including a nonionic polymer wherein the first polymer and second polymer each fill at least a portion of the void volume.

2. The composite membrane of claim 1 wherein the first polymer is a perfluorosulfonic acid polymer (PFSA).

3. The composite membrane of claim 1 wherein the first polymer is a copolymer containing repeating units based on tetrafluoroethylene and repeating units represented by (CF₂—CF)—(OCF₂CFX)ₘ—Oₚ—(CF₂)ₙ—SO₃H, where X represents a fluorine atom or a trifluoromethyl group, m represents an integer from 0 to 3, n represents an integer from 1 to 12 and p represents an integer of 0 or 1.

4. The composite membrane of claim 3 wherein m=1, X=CF₃, p=1, and n=2.

5. The composite membrane of claim 3 wherein m=0, p=1, and n=2.

6. The composite membrane of claim 3 wherein m=0, p=1, and n=4.

7. The composite membrane of claim 1 wherein the first polymer comprises a polymer selected from the group of polymers having the following formulae: 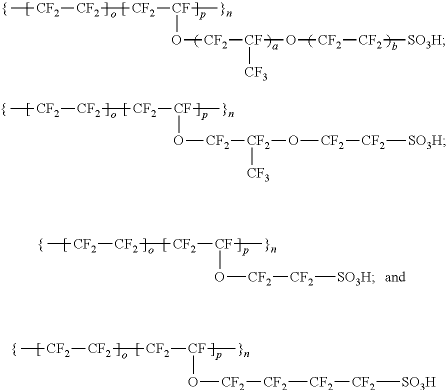
where o, p, n, are integers such that there are less than 15 o segments for each p segment.

8. The composite membrane of claim 1 wherein the second polymer comprises fluoropolymers.

9. The composite membrane of claim 8 wherein the second polymer comprises a fluoro-elastomer.

10. The composite membrane of claim 8 wherein the second polymer comprises a component selected from the group consisting of poly(tetrafluoroethlyene-co-ethylene), poly(vinylidene fluoride-co-hexafluoropropylene), poly(tetrafluoroethylene-co-propylene), terpolymers of vinylidene fluoride, hexafluoropropylene and tetrafluoroethylene, and terpolymers of ethylene, tetrafluoroethylene and perfluoromethylvinylether.

11. A composite membrane for fuel cells, the composite membrane comprising:
an expanded polytetrafluoroethylene substrate having a predefined void volume;
a first polymer comprising a copolymer containing repeating units based on tetrafluoroethylene and repeating units represented by (CF₂—CF)—(OCF₂CFX)ₘ—Oₚ—(CF₂)ₙ—SO₃H, where X represents a fluorine atom or a trifluoromethyl group, m represents an integer from 0 to 3, n represents an integer from 1 to 12 and p represents an integer of 0 or 1; and
a second polymer comprising a fluoropolymer wherein the first polymer and second polymer each fill at least a portion of the void volume.

12. The composite membrane of claim 11 wherein m=1, X=CF₃, p=1, and n=2.

13. The composite membrane of claim 12 wherein m=0, p=1, and n=2.

14. The composite membrane of claim 12 wherein m=0, p=1, and n=4.

15. The composite membrane of claim 11 wherein the second polymer comprises a fluoro-elastomer.

16. The composite membrane of claim 11 wherein the fluoropolymer comprises a component selected from the group consisting of poly(tetrafluoroethlyene-co-ethylene), poly(vinylidene fluoride-co-hexafluoropropylene), poly(tetrafluoroethylene-co-propylene), terpolymers of vinylidene fluoride, hexafluoropropylene and tetrafluoroethylene, and terpolymers of ethylene, tetrafluoroethylene and perfluoromethylvinylether.

17. A polymer electrolyte membrane for fuel cells, the polymer electrolyte membrane comprising:
a composite membrane having a first side and a second side, the composite membrane including:
an expanded polytetrafluoroethylene substrate having a predefined void volume;
a first polymer having a chemical moiety described by formula (I): 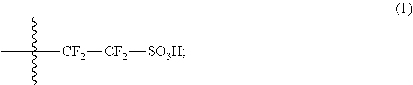
and
a second polymer including a non-ionic fluoropolymer wherein the first polymer and second polymer each fill at least a portion of the void volume;
a cathode disposed on the first side; and
an anode disposed on the second side.

18. The polymer electrolyte membrane of claim 17 wherein the first polymer is a copolymer containing repeating units based on tetrafluoroethylene and repeating units represented by (CF₂—CF)—(OCF₂CFX)ₘ—Oₚ—(CF₂)ₙ—SO₃H, where X represents a fluorine atom or a trifluoromethyl group, m represents an integer from 0 to 3, n represents an integer from 1 to 12 and p represents an integer of 0 or 1.

19. The polymer electrolyte membrane of claim 17 wherein the second polymer comprises a component selected from the group consisting of poly(tetrafluoroethlyene-co-ethylene), poly(vinylidene fluoride-co-hexafluoropropylene), poly(tetrafluoroethylene-co-propylene), terpolymers of vinylidene fluoride, hexafluoropropylene and tetrafluoroethylene, and terpolymers of ethylene, tetrafluoroethylene and perfluoromethylvinylether.
